(19) United States
(12) Patent Application Publication
(10) Pub. No.: US 2007/0190408 A1
(43) Pub. Date: Aug. 16, 2007

(54) Separator and method of manufacturing non-aqueous electrolyte secondary battery using the same

(76) Inventors: Kaoru Inoue, Osaka (JP); Masato Fujikawa, Osaka (JP); Takayuki Shirane, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/705,417

(22) Filed: Feb. 13, 2007

(30) Foreign Application Priority Data
Feb. 16, 2006 (JP) 2006-039013

(51) Int. Cl. H01M 2/16; H01M 4/58

(52) U.S. Cl. 429/145; 29/623.1; 429/218.1

(57) ABSTRACT

A separator includes a porous sheet, a heat-resistant porous layer, and a metal lithium layer. The heat-resistant porous layer is provided on one of surfaces of the porous sheet. The metal lithium layer is provided on the surface of the heat-resistant porous layer. The separator is disposed between a negative electrode that includes an active material capable of reversibly storing and emitting lithium ions and having a theoretical capacity density of 400 mAh/g or higher, and a positive electrode capable of reversibly storing and emitting lithium ions, so that the metal lithium layer faces the negative electrode.

### BACKGROUND OF THE INVENTION

1. Field of the Invention

The present invention relates to a separator for use in a non-aqueous electrolyte secondary battery. It particularly relates to a separator for compensating for the irreversible capacity of the negative electrode active material having high capacity density and for improving safety in an internal short circuit, and a method of manufacturing a non-aqueous electrolyte secondary battery using the separator.

2. Background Art

With the advancement of portable and cordless electronic equipment, there are growing expectations for more lightweight non-aqueous electrolyte secondary batteries having higher energy density. At present, as negative electrode active materials of a non-aqueous electrolyte secondary battery, carbon materials such as graphite are put into practical use. The theoretical capacity density of the carbon materials is 372 mAh/g. Thus, to provide much higher energy density for a battery, Si, Sn, and Ge alloyable with lithium, and oxides and alloys thereof are raising expectations as a negative electrode active material having higher theoretical capacity density. In particular, inexpensive Si, and silicon-containing compounds such as silicon oxides are studied in a wide range.

However, when a high capacity density material having a theoretical capacity density of 400 mAh/g or higher is used as a negative electrode active material, the substance shows an irreversible capacity much larger than that of graphite, during initial charge and discharge operation. For this reason, the battery cannot show a capacity as much as expected. In order to compensate for an amount of lithium corresponding to the irreversible capacity, Japanese Patent Unexamined Publication No. H05-144472, for example, proposes a method of providing lithium foil on the surface of a negative electrode in advance so that lithium ions are electrochemically stored into the negative electrode.

However, when an excessive amount of metal lithium remains on the negative electrode after initial charge and discharge operation, dendrite-like lithium deposits on the remaining lithium during charging thereafter. When such dendrite-like lithium grows, it reaches the positive electrode and causes an internal short circuit. For this reason, it is preferable that the metal lithium is formed into a thin film having a thickness of approximately several micrometers by vapor deposition and provided on the negative electrode. However, in vapor deposition, the negative electrode, i.e. a substrate on which deposition is to be provided, is heated. Because the negative electrode includes a negative electrode active material of which phase is changed by heating, and organic components having low heat resistance, such as a binder, the characteristics of the negative electrode is degraded by lithium deposition provided thereon.

### SUMMARY OF THE INVENTION

A separator of the present invention includes a porous sheet, a heat-resistant porous layer, and a metal lithium layer. The heat-resistant porous layer is provided on the surface of the porous sheet on one side thereof. The metal lithium layer is provided on the surface of the heat-resistant porous layer. The separator is disposed between a negative electrode that includes an active material capable of reversibly storing and emitting lithium ions and having a theoretical capacity density of 400 mAh/g or higher, and a positive electrode capable of reversibly storing and emitting lithium ions, so that the metal lithium layer faces the negative electrode.

### BRIEF DESCRIPTION OF THE DRAWINGS

FIG. 1 is a partially cutaway view in perspective of a non-aqueous electrolyte secondary battery fabricated in accordance with an exemplary embodiment of the present invention.

FIG. 2 is an exploded view in perspective of the non-aqueous electrolyte secondary battery shown in FIG. 1.

FIG. 3 is an enlarged conceptual sectional view of an electrode group of the non-aqueous electrolyte secondary battery shown in FIG. 1 before a non-aqueous electrolyte is poured into the battery.

FIG. 4 is a conceptual sectional view of a separator of the exemplary embodiment of the present invention before the battery is assembled.

FIG. 5 is a conceptual sectional view of another separator of the exemplary embodiment of the present invention before the battery is assembled.

### DETAILED DESCRIPTION OF THE INVENTION

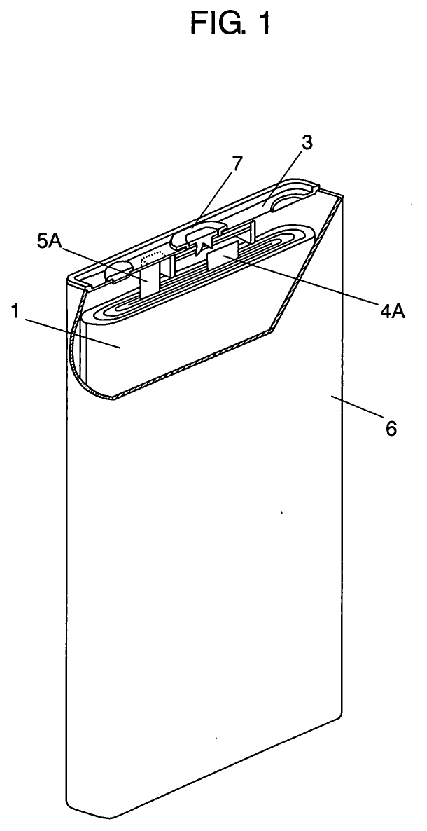

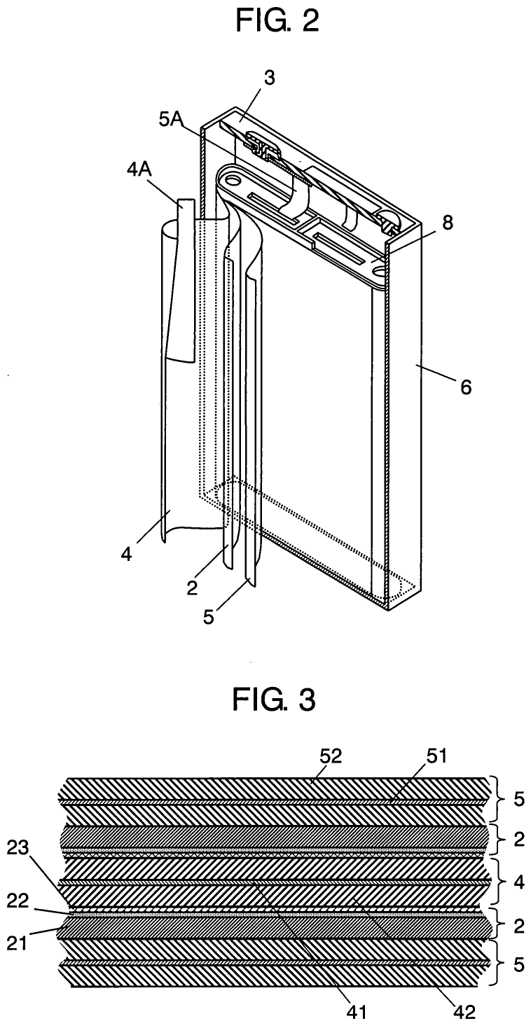

FIG. 1 is a partially cutaway view in perspective of a non-aqueous electrolyte secondary battery fabricated in accordance with an exemplary embodiment of the present invention. FIG. 2 is an exploded view in perspective of the non-aqueous electrolyte secondary battery. FIG. 3 is an enlarged conceptual sectional view of an electrode group of the non-aqueous electrolyte secondary battery show in FIG. 1 before a non-aqueous electrolyte is charge into the battery.

This prismatic battery includes negative electrode 4, positive electrode 5 facing negative electrode 4 and reducing lithium ions during discharge, and separator 2 disposed between positive electrode 4 and negative electrode 5 and preventing them from direct contact each other. Negative electrode 4 and positive electrode 5 are wound together with separator 2 to form electrode group 1. Electrode group 1 is housed in case 6 together with a non-aqueous electrolyte solution not shown in the drawing, which is a non-aqueous electrolyte disposed between negative electrode 4 and positive electrode 5. Disposed on electrode group 1 is frame 8 made of a resin that separates electrode group 1 from sealing plate 3 and lead 4A from case 6.

Negative electrode 4 includes current collector 41 and negative electrode active material layer 42 provided on the surfaces of current collector 41. Lead 4A is attached to current collector 41. The other end of lead 4A is provided on sealing plate 3, and connected to terminal 7 electrically insulated from sealing plate 3 and case 6.

Negative electrode active material layer 42 contains an active material, i.e. a high capacity density material capable of reversibly storing and emitting lithium ions and having a theoretical capacity density of 400 mAh/g or higher. The materials of such an active material are not specifically limited. Silicon (Si), aluminum (Al), zinc (Zn), germanium (Ge), cadmium (Cd), tin (Sn), lead (Pb), and compounds thereof can be used as the active material. Theses materials may be used by itself or in combination of at least two kinds. Using an element alloyable with lithium, particularly Si or Sn, is preferable to provide a material capable of storing a large amount of lithium and easily obtainable. The usable Si- and Sn-containing materials include: the elements such as Si and Sn; oxides such as SiOₓ (0<x<2) and SnOₓ (0<x≦2); alloys containing transition metal elements such as Ni—Si alloys, Ti—Si alloys, Mg—Sn alloys, and Fe—Sn alloys. These Si-containing materials are preferable because they have large irreversible capacity particularly among materials having high capacity density and thus are likely to exert the advantages of this exemplary embodiment in structuring a non-aqueous electrolyte secondary battery having high capacity.

When an active material in particle form is applied to current collector 41, polyvinylidene-fluoride (PVDF), styrene-butadiene copolymers (SBR), or modified acrylic acid-based polymers can be used, as a binder. When a water-based paste is applied to current collector 41, the use of carboxymethylcellulose (CMC) or polyacrylic acid as a water-soluble thickener can improve the stability of the paste. Many of the above materials having high capacity density are poor in electrical conductivity. Thus, graphites such as artificial graphite, carbon blacks such as acetylene black and Ketjen black, or carbon fibers may be added as a conductive agent. The active material may be deposited directly on current collector 41 by chemical vapor deposition to form negative electrode active material layer 42.

For negative electrode current collector 41, lead 4A, and terminal 7, metal foils made of stainless steel, nickel, cupper, or titanium, or thin films made of carbon or conductive resin can be used. Further, surface treatment may be provided thereon by carbon, nickel, or titanium.

Positive electrode 5 includes current collector 51 and positive electrode active material layer 52 provided on the surfaces of current collector 51. Lead 5A is attached to current collector 51. The other end of lead 5A is connected to case 6 also working as a positive terminal, via sealing plate 3.

The examples of the active material contained in positive electrode active material layer 52 include lithium cobaltate (LiCoO₂), LiNiₓCo_{y}O₂ (x+y=1), and LiNiₓMn_{y}Co_{z}O₂ (x+y+z=1). These active materials are in particle form, and forms positive electrode active material layer 52 that can be applied to current collector 51. At this time, PVDF or polytetrafluoroethylene (PTFE) can be used as a binder. When a water-based paste is prepared for application, CMC or polyacrylic acid can be used as a water-soluble thickener. The above active materials are poor in electrical conductivity, and thus it is preferable to add graphites such as artificial graphite, carbon blacks such as acetylene black and Ketjen black, or carbon fibers as a conductive agent.

The materials usable for current collector 51, lead 5A, and case 6 include aluminum (Al), carbon, and conductive resin. Surface treatment may be provided on any of these materials by carbon or the like.

The materials usable for the non-aqueous electrolyte include: those containing a salt, such as LiPF₆, LiBF₄, LiCF₃SO₃, LiN(CF₃SO₂)₂, and LiN(C₂F₅SO₂)₂, dissolved in an organic solvent, such as ethylene carbonate (EC), diethyl carbonate (DEC), ethyl methyl carbonate (EMC), dimethyl carbonate (DMC), and propylene carbonate (PC). The above organic solvents may be used by itself or in combination. To improve safety and life characteristics of the battery, an additive such as cyclohexylbenzene (CHB) and vinylene carbonate (VC) may be added to these non-aqueous electrolytes.

Alternatively, the non-aqueous electrolyte may be used in gel form by mixing one of the above solutes and at least one of the above organic solvents into a mixture of at least one of the following polymeric materials: polyethylene oxide, polypropylene oxide, polyphosphazene, polyaziridine, polyethylene sulfide, polyvinyl alcohol, polyvinylidene-fluoride, and polyhexafluoropropylene.

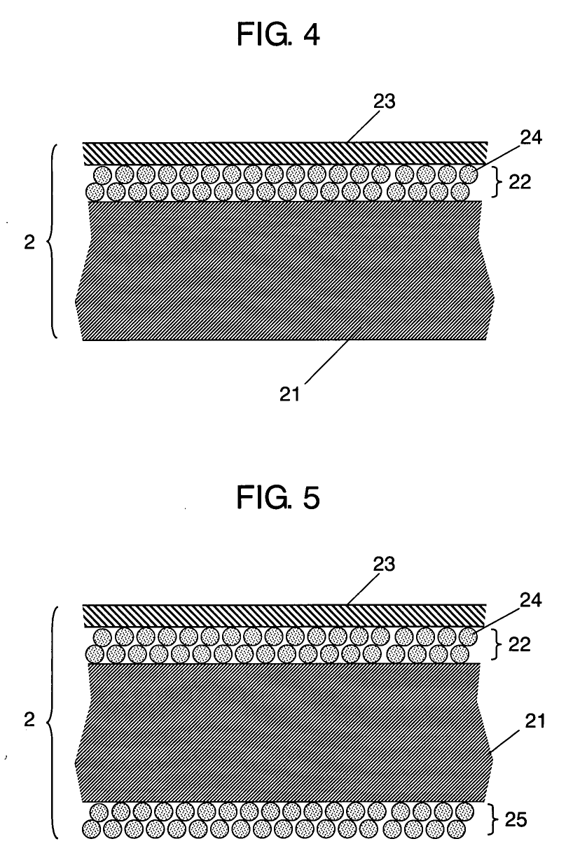

FIG. 4 is a conceptual sectional view illustrating a structure of separator 2 before assembled into a battery. First heat-resistant porous layer (hereinafter referred to as a “heat-resistant layer”) 22 is provided on one of the surfaces of porous sheet 21, i.e. a substrate. Further, metal lithium layer 23 is provided on the surface of heat-resistant layer 22. When electrode group 1 is fabricated, separator 2 is disposed between positive electrode 5 and negative electrode 4 so that metal lithium layer 23 faces negative electrode 4. Then, a non-aqueous electrolyte is disposed between separator 2 and negative electrode 4 so that the active material of negative electrode 4 stores lithium ions from metal lithium 23 to compensate for the irreversible capacity. This method can compensate for the irreversible capacity of the active material after initial charge and discharge operation and avoids short circuits which may occur thereafter. When metal lithium layer 23 is provided to face positive electrode 5 unlike the structure of this exemplary embodiment, this method cannot compensate negative electrode 4 for an amount of lithium corresponding to the irreversible capacity.

To dispose a non-aqueous electrolyte between separator 2 and negative electrode 4, electrode group 1 may be impregnated with a non-aqueous electrolyte, after electrode group 1 is fabricated. Alternatively, after insertion of electrode group 1 into case 6, a non-aqueous electrolyte may be poured into case 6. In this case, battery assembly and irreversible capacity compensation can be performed at the same time.

As porous sheet 21, a micro-porous membrane made of polyolefins, such as polyethylene and polypropylene, can be used. The thickness of the sheet is not specifically limited; however, preferably, the thickness ranges from 10 to 30 μm (inclusive) so that the sheet has a proper mechanical strength and is suitable to provide higher capacity.

For heat-resistant layer 22, the materials can be usable, which have a melting point and thermal decomposition temperature largely exceeding 200° C., i.e. a temperature at which a substrate may reach in normal vacuum deposition. The examples of usable organic materials are heat-resistant resin, such as PTFE, polyimide, and polyamide, in the forms of particles or porous membranes. As inorganic materials, inorganic oxide particles 24 such as powders of aluminum oxide (alumina), silicon dioxide, titanium dioxide, zirconium oxide, and magnesium oxide can be used. Inorganic oxide particles 24 are more highly heat-resistant than the particles of heat-resistant resin. Further, when negative electrode active material layer 42 containing an active material made of a material having high capacity density expands during charging, the proper hardness of inorganic oxide particles 42 can ensure the clearance between positive electrode 5 and negative electrode 4, and keep the ion conductivity at high levels. For these reasons, inorganic oxide particles 42 are preferable.

When materials in particle form are used for heat-resistant layer 22, it is more preferable to add a binder such as PVDF and rubber particles having acryl units, to heat-resistant layer 22 so that adherence between porous sheet 21 and heat-resistant layer 22 can be ensured. The above binders have inhibited tendency to be swollen by non-aqueous electrolytes in addition to proper heat resistance, and thus can keep the pores in heat-resistant layer 22 and ion conductivity.

Metal lithium layer 23 can easily be formed by vapor deposition processes such as various kinds of sputtering methods and vacuum deposition methods. The amount of lithium does not excess enough to compensate for the irreversible capacity with metal lithium layer 23 up to 30 μm in thickness, although it depends on the capacity of negative electrode 4 per unit area facing the metal lithium layer. It is industrially difficult to form metal lithium layer 23 up to 30 μm in thickness in foil form. Even if such foil can be formed, remarkable deterioration of mechanical strength makes handling thereof difficult during battery assembly.

Metal lithium layer 23 may be provided separately on heat-resistant layer 22. This case is preferable because separator 2 is not completely covered with metal lithium layer 23 and thus the ion conductivity between positive electrode 5 and negative electrode 4 can be set higher from the beginning. However, extremely separated deposition localizes the portions in which negative electrode active material layer 42 stores lithium ions. Thus, moderately separated deposition of metal lithium layer 23 on heat-resistant layer 22 is necessary.

Porous sheet 21 is mainly formed of a resin having a melting point up to 200° C., such as polyolefins. For this reason, deposition of metal lithium layer 23 directly on the surface of porous sheet 21 deforms and melts porous sheet 21. To address this problem, heat-resistant layer 22 is provided on the surface of porous sheet 21, and metal lithium layer 23 is provided on the surface of heat-resistant layer 22 so as to face negative electrode 4. This structure can prevent porous sheet 21 from being deformed and melted by heat, and avoid a capacity decrease caused by the irreversible capacity.

Even if the heat during deposition partially degrades the material of heat-resistant layer 22, the degraded components remain in heat-resistant layer 22. This doesn't produce a capacity decrease caused by a reduction in the reaction areas of positive electrode 5 and negative electrode 4, and various decomposition reactions caused at the potential of negative electrode 4. Further, the high heat-resistance of heat-resistant layer 22 inhibits porous sheet 21 from melting even if the entry of a sharp conductor short-circuits positive electrode 5 and negative electrode 4. This provides an advantage of avoiding abnormal overheat caused by expanded short-circuited sites.

As shown in FIG. 5, second heat-resistant porous layer 25 can be provided on the surface of porous sheet 21 on the side opposite to heat-resistant layer 22 so that porous sheet 21 has the heat-resistant porous layers on both sides thereof. This structure improves the heat resistance and thus safety when the entry of a sharp conductor short-circuits positive electrode 5 and negative electrode 4.

In the above description, a prismatic battery is used as an example of a non-aqueous electrolyte secondary battery. However, the structure and shape of the battery are not limited to this example. A non-aqueous electrolyte secondary battery of the present invention can be fabricated by inserting the above components into a cylindrical or substantially prismatic case and sealing the case. Any case can be used if it has a hermetically-sealed structure when sealed. Box-shaped metals or resins, or laminated bags can be used. Used in the above description is a structure including active material layers on both sides of each current collector, as a positive electrode and negative electrode. However, the active material layer may be provided only on one side. In application of the present invention for a coin-shaped battery, the active material layer may be formed directly on a case or lid without using any current collector.

Hereinafter, the advantages of this exemplary embodiment are described with reference to specific examples. First, a method of fabricating a battery of Sample A is described.

### (1) Fabrication of Negative Electrode and Determination of Irreversible Capacity

After particles of silicon monoxide, i.e. a silicon-containing compound, are pulverized and classified to have an average particle diameter of 10 μm, the particles are charged into a solution obtained by dissolving one part by weight of nickel (II) nitrate hexahydrate in 100 parts by weight of ion-exchange water. After this mixture is stirred for one hour, moisture is removed by an evaporator. This operation allows silicon monoxide particles to support nickel nitrate on the surfaces thereof.

The silicon monoxide particles supporting nickel nitrate are charged into a ceramic reactor, and heated-up to 550° C. in the presence of helium gas. Then, the helium gas is substituted by a mixed gas of 50 vol. % of hydrogen gas and 50 vol. % of methane gas, and kept at 550° C. for ten minutes to reduce nickel nitrate and grow carbon nanofibers on the surfaces of the silicon monoxide particles. Next, the mixed gas is substituted by helium gas again, and the contents of the reactor are cooled to room temperature. Thereafter, the contents are heated-up to 1,000° C. in the presence of argon gas, and fired at 1,000° C. for one hour to provide a negative electrode complex active material.

One hundred parts by weight of this complex active material, PVDF dispersion containing 7 parts by weight of PVDF solids, and a proper amount of N-methyl-2-pyrrolidone (NMP) are mixed to provide negative electrode mixture slurry.

The obtained slurry is applied to both sides of current collector 41 made of 15-μm-thick copper foil with a doctor blade and dried in a drier at a temperature of 60° C. to allow current collector 41 to support negative electrode active material layer 42. The obtained sheet is punched into a rectangular shape of 32 mm-wide and 42 mm-long to provide negative electrode 4.

Next, negative electrode 4 and a metal lithium sheet of 300 μm-thick are combined via a polyethylene micro-porous membrane into a planar shape, and inserted into a laminated bag. A non-aqueous electrolyte solution containing 1 mol/L of LiPF₆ dissolved in a mixed solvent of EC and DEC is poured into the bag and the bag is sealed to provide a test cell. This test cell is charged and discharged at 3 mA, and the reversible capacity and irreversible capacity of negative electrode 4 are obtained from the initial charging capacity and discharging capacity. As a result, the reversible capacity and the irreversible capacity per unit area are determined to 5 mAh/cm² and 2 mAh/cm², respectively. Calculations using these results determine that the thickness of metal lithium layer 23 to be formed on separator 2 is 6.3 μm.

### (2) Fabrication of Separator

Using the above-mentioned polyethylene micro-porous membrane as porous sheet 21, heat-resistant layer 22 is formed on one side thereof. Heat-resistant layer 22 is formed in the following manner:

As inorganic oxide particles 24, alumina having an average particle diameter of 0.7 μm is used. One hundred parts by weight of alumina, 3 parts by weight of PVDF as a binder, and a proper amount of NMP are mixed to provide slurry. This slurry is applied to one side of porous sheet 21 with a doctor blade and dried in a drier at a temperature of 60° C. to form 5-μm-thick heat-resistant layer 22 on porous sheet 21.

Further, metal lithium is heated using an electronic resistor in a vacuum chamber so as to be deposited on porous sheet 21 including heat-resistant layer 22 formed thereon. In this manner, 6.3-μm-thick metal lithium layer 23 is formed on heat-resistant layer 22 to provide separator 2.

### (3) Fabrication of Positive Electrode

One hundred parts by weight of LiCoO₂, 3 parts by weight of acetylene black as a conductive agent, 2 parts by weight of PVDF as a binder, and a proper amount of NMP are mixed to prepare slurry of a positive electrode mixture. This slurry is applied to both sides of current collector 51 made of 15-μm-thick aluminum foil with a doctor blade, dried in a drier at a temperature of 60° C., and roll-pressed. In this manner, positive electrode active material layers 52 are formed on both sides of current collector 51. The obtained sheet is punched into a rectangular shape of 30 mm-wide and 40-mm long to provide positive electrode 5. The capacity of positive electrode 5 per unit area is 5 mAh/cm².

### (4) Fabrication of Non-Aqueous Electrolyte Secondary Battery

Positive electrode 5 and negative electrode 4 are combined via separator 2 into a planar shape, and inserted into a laminated bag. At this time, metal lithium layer 23 on separator 2 is faced toward negative electrode 4. As a non-aqueous electrolyte, the same solution used to determine the irreversible capacity of negative electrode 4 is used. This solution is poured into the laminated bag and the bag is sealed to provide a non-aqueous electrolyte secondary battery. This is the battery of Sample A.

For Sample B, instead of alumina as inorganic oxide particles 24 in Sample A, aramid particles having the same particle diameter are used in heat-resistant layer 22 of separator 2. A non-aqueous electrolyte secondary battery fabricated in the same manner as Sample A except for the inorganic oxide particles is the battery of Sample B.

For comparison with Samples A and B, the following samples are fabricated. For Sample C, the separator includes no metal lithium layer 23 and includes only porous sheet 21 and heat-resistant layer 22 in contrast to Sample A. A non-aqueous electrolyte secondary battery fabricated in the same manner as Sample A except for the separator is the battery of Sample C. For Sample D, the separator includes no heat-resistant layer 22 and includes only porous sheet 21 and metal lithium layer 23 formed directly on porous sheet 21 in contrast to Sample A. A non-aqueous electrolyte secondary battery fabricated in the same manner as Sample A except for the separator is the battery of Sample D. For Sample E, the separator only includes porous sheet 21 in contrast to Sample A. A non-aqueous electrolyte secondary battery fabricated in the same manner as Sample A except for the separator is the battery of Sample E. For Sample F, a metal lithium layer of 6.3 μm-thick is provided on negative electrode 4 fabricated in the same manner as Sample A by the vacuum deposition method. Further, a separator similar to that of Sample E is used. A non-aqueous electrolyte secondary battery fabricated in the same manner as Sample A except for this structure is the battery of Sample F.

For each of these samples, the appearance of each of the separator is observed, each of the fabricated batteries is charged and discharged at 3 mA in an atmosphere at 25° C., and the initial charging capacity and discharging capacity are measured. Then, the irreversible capacity is obtained from the difference between the initial charging capacity and discharging capacity, and a rate thereof with respect to the initial charging capacity is obtained in percent figures. Further, 500 cycles of charge-discharge operation are repeated on the sample batteries. In each cycle, after charged at a constant current of 60 mA to 4.2V in an atmosphere at 25° C., each of the batteries is charged at a constant voltage of 4.2V until the current thereof decreases to 3 mA, and discharged at a constant current of 60 mA to 2.0 V. Then, for each sample, a rate of the discharging capacity in the 500th cycle with respect to the discharging capacity in the second cycle is obtained in percent figures to calculate a capacity retention as an index of charge-discharge cycle characteristics. Table 1 shows the data and evaluation results of each sample.

TABLE 1

| | Separator | | Lithium layer | | | Capacity |
|---|---|---|---|---|---|---|
| | Heat-resistant | Lithium | on negative | Deformation | Irreversible | retention |
| Sample | layer | Layer | electrode | of separator | capacity | (%) |
| A | Alumina | Exist | None | None | Up to 3% | 85 |
| | particle | | | | | |
| B | Aramid | Exist | None | None | Up to 3% | 80 |
| | particle | | | | | |
| C | Alumina | None | None | None | 35% | 85 |
| | particle | | | | | |
| D | None | Exist | None | Exist | 15% | 50 |
| E | None | None | None | None | 35% | 70 |
| F | None | None | Exist | None | Up to 5% | 55 |

For each of batteries of Samples C and E with no metal lithium layer 23, the irreversible capacity is large. For Sample D including metal lithium layer 23 provided directly on porous sheet 21, the irreversible capacity is slightly decreased; however, the heat generated during deposition of metal lithium layer 23 deforms porous sheet 21 having low heat resistance. Such a deformation is not preferable because it causes internal short circuits. For Sample F, metal lithium is deposited on the negative electrode. In this case, the irreversible capacity is decreased; however, thermal degradation of the negative electrode considerably degrades the cycle characteristics. In contrast to these comparative examples, metal lithium layer 23 can be provided without deformation of porous sheet 21, for each of Samples A and B both in accordance with the practical example of the present invention. Further, each of Samples A and B has more excellent life characteristics than Sample F including a metal lithium layer provided directly on the negative electrode.

As described above, a separator of the present invention can inhibit decreases in the discharging capacity of a non-aqueous electrolyte secondary battery caused by the large irreversible capacity when a material having high capacity density is used for the negative electrode active material. Non-aqueous electrolyte secondary batteries fabricated by using a separator of the present invention are useful for main power supplies for mobile communications equipment and portable electronic equipment, for example.

1. A separator comprising:
a porous sheet;
a first heat-resistant porous layer provided on one of surfaces of the porous sheet; and
a metal lithium layer provided on a surface of the first heat-resistant porous layer.

2. The separator according to claim 1 further comprising:
a second heat-resistant porous layer provided on another surface of the porous sheet on a side opposite to the side having the first heat-resistant porous layer thereon.

3. The separator according to claim 1, wherein the first heat-resistant porous layer includes particles of an inorganic oxide.

4. A method of manufacturing a non-aqueous electrolyte secondary battery comprising:
disposing a separator between a negative electrode and a positive electrode to fabricate an electrode group, the negative electrode including an active material capable of reversibly storing and emitting lithium ions and having a theoretical capacity density of at least 400 mAh/g, the positive electrode being capable of reversibly storing and emitting lithium ions, and the separator including a porous sheet, a first heat-resistant porous layer provided on one of surfaces of the porous sheet, and a metal lithium layer provided on a surface of the first heat-resistant porous layer, the separator being disposed so that the metal lithium layer faces the negative electrode; and
disposing a non-aqueous electrolyte between the separator and the negative electrode to allow the active material of the negative electrode to store lithium ions from the metal lithium layer.

5. The method of manufacturing the non-aqueous electrolyte secondary battery according to claim 4, wherein the active material of the negative electrode is a silicon-containing material.
